(19) United States
(12) Patent Application Publication
(10) Pub. No.: US 2008/0239072 A1
(43) Pub. Date: Oct. 2, 2008

(54) Door monitor with a portable storage medium

(76) Inventor: Ming-Te Cheng, Taoyuan City (TW)

Correspondence Address: Frenkel & Associates, P.C., Suite 330, 3975 University Drive, Fairfax, VA, 22030, US

(21) Appl. No.: 11/728,337

(22) Filed: Mar. 26, 2007

(51) Int. Cl. H04N 7/18

(52) U.S. Cl. 348/143

(57) ABSTRACT

A door monitor with a portable storage medium includes a host module disposed behind the door, a night-vision camera module disposed outside the door and electrically connected with the host module, a sensor disposed outside the door for detecting whether any object is approaching, and a microphone connected with the host module. The host module has a multimedia processor, a display, a touch panel, and a portable storage medium connecting interface. The user enters monitoring criteria using the touch panel. When an object approaches and stays for a period of time, the night-vision camera module starts recording. The recorded video data are sent to and played on the display. The video data are compressed in a format and stored on the portable storage medium. The door monitor readily monitors situations outside the door and records and stores video images for the purposes of home security.

### BACKGROUND OF THE INVENTION

1. Field of the Invention

The invention relates to security door monitor and, in particular, to a security door monitoring by having a portable storage medium to capture instant images and conduct storage of video images after a predicted time.

2. Description of Related Art

In view of increasing crime rate on house breaking cases, it is almost impossible for any working adults to leave home with doors unlocked at any times. In regards, such concern and crime rate have led to a prosperous development of the security industries over the decade. This day most of the residence main door comes with a standard magnify peephole that allows the house owner to view any visitors outside the main door before deciding whether to open it.

However, according to our knowledge in research and market survey from most of the end users, common experience in using the peephole shows the peephole do not provide significant images as the images are usually deformed due to distances/light brightness/poor angle of view. Moreover the current design of peephole does not provide any auto image detection function at all.

Therefore our current invention of security door monitor with its capability to enhance to end users a sense of TRUTH security after installed.

### SUMMARY OF THE INVENTION

In this current market most of the security door monitors just provide a real-time monitoring function without the active monitoring function. Even some products do have the video recording function the data storage scheme is not suitable for easy access or other links.

The objective of our invention is to enhance the security door monitor with an auto monitoring and video storage functions.

The invention provides a portable storage medium that is used to store video data.

When an object approaches and stays more than a predicted period of time (set in the system) without leaving, the detection and monitoring start its recording functions automatically.

These captured images are directly played inside the main door and will be compressed into a format supported by the portable storage medium as part of data collected.

If the video data are required to be retrieved, the portable storage medium can be directly removed for copying or other purposes. For example, the portable storage can be connected to a TV or a security post monitor.

The components of the security door monitor comprise:

a night-vision camera module located outside the main door via through peephole for capturing object or images outside despite during the dim lighting condition;

a mini microphone will also be hidden for capturing sounds outside the key hole of the main door; and

a sensor for detector located at key hole of the main door will be added to detect via by IR for any object that is approaching from distance outside the main door.

The above components are in signal communication with a host module that is disposed behind the main door, and electrically connects to the night-vision camera module, the microphone and the sensor detector.

The host module comes in rectangle dimension like a box. The host module has a display located in the front of the box. The display can be made by a touch panel.

The main application of this box is to provide a connecting interface for the portable storage medium, this is to serve as recording by a multimedia processor that is located inside the box.

To activate the security door monitor function, the portable storage medium is require to be inserted into the compartment so that interfacing job for the multimedia processor to perform input/output (I/O).

So during the security door monitor is in operation, the detector sensor outside the door will carry out its function by detecting any person or object that is approaching.

Once a person or object is approaching and stay longer than the predetermined time; the multimedia processor starts its recording function by the timer that had been pre-set.

If the person or object leaves within a predetermined time, the image/voice monitoring and video recording functions do not start.

However if the person or object stays longer than the predetermined time, the multimedia processor will start recording the night-vision camera module (if the lighting intensity is too dim) and this include sound recording by the microphone.

The recorded image data can be view from the display.

In addition, those video/audio data captured by the night-vision camera module and the microphone are being compressed in a specific format at the same time. These compressed data are written via the connecting interface into the portable storage medium. Since a portable storage medium is used for storing the data, it can be detached from the host module for copying and other purposes such as linking to a TV or security department control room.

This image detector is installed outside the main door via the peephole.

There is a control module installed inside the main door and electrically harness with the image detector.

The control module has a capability to process for instant display and storage any detected images via from the peephole on whatever events carry out outside the main door.

Therefore, the house owners do not need to view via through the peephole to check situations outside the main door because they could see from the display panel from the control module or to play back for whatever that had been recorded earlier.

In other words, the displayed images simply provide passive real-time monitoring events around the clock 7 days a week and 24 hours a day.

Such application do not require a person attentively watching the displayed images through out the day, because its serve its application actively and effectively despite the house owners have to leave home

From the above brief elaboration of the security door monitors invention its will leverage a big improvement on the current traditional peephole design that had been around over the last few decade.

Our primary aim for such invention on the security door monitor is to enhance higher level of security to any house owners and possibility to retrieve storage data any time they wish.

### BRIEF DESCRIPTION OF THE DRAWINGS

FIG. 1 is a front view of the disclosed embodiment;

FIG. 2 is a back view of the disclosed embodiment;

FIG. 3 is a side view of the disclosed embodiment; and

FIG. 4 shows the circuit diagram of the disclosed embodiment.

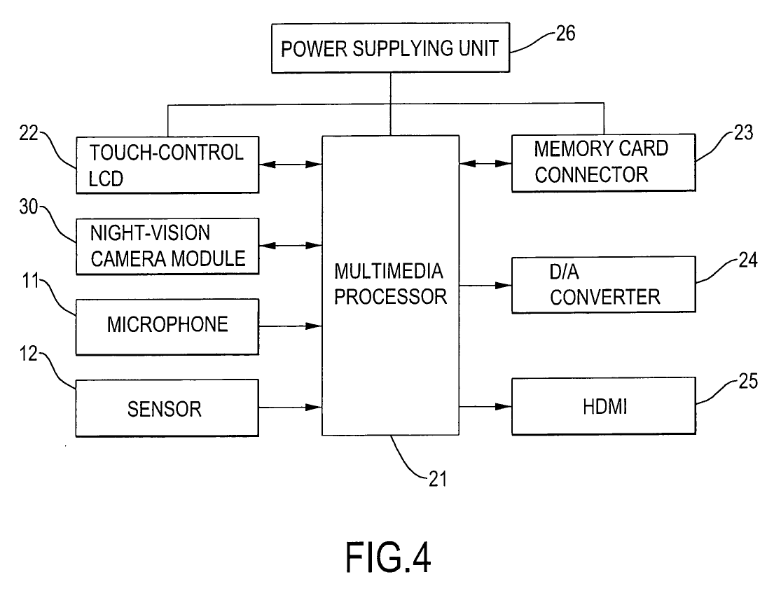

### DETAILED DESCRIPTION OF THE PREFERRED EMBODIMENT

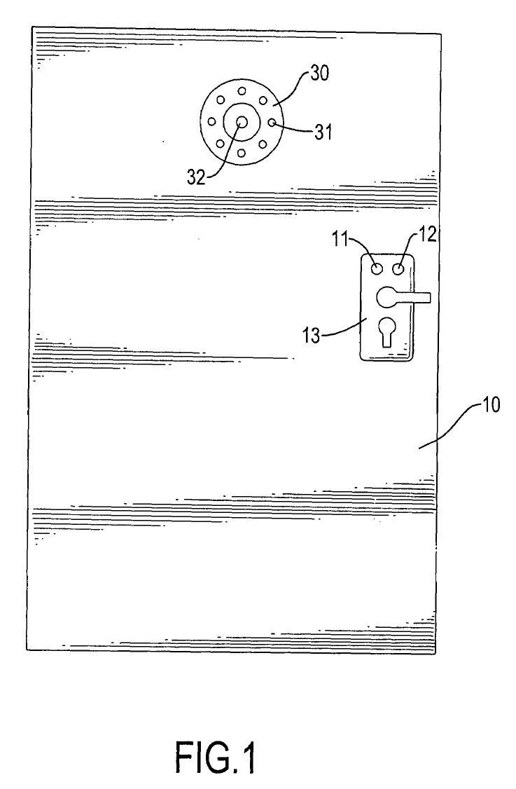

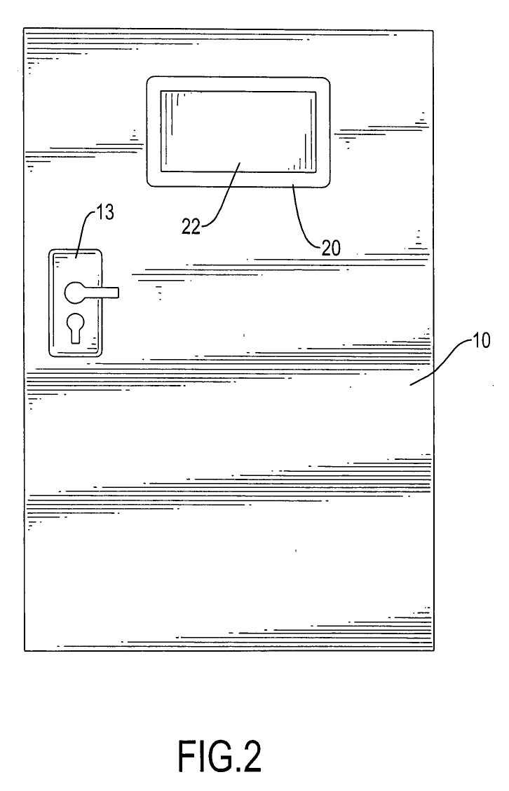

As shown in FIGS. 1 and 2, the structure installed on a door 10 according to a preferred embodiment of the invention includes a host module 20 disposed behind the door 10, a night-vision camera module 30 disposed outside the door 10 and in signal communications with the host module 20, a microphone 11, and a sensor 12. The night-vision camera module 30 has several infrared (IR) light-emitting diodes (LED's) surrounding a circular frame in order to provide night-vision illumination when the environment is not sufficiently bright. A video signal capturer 32, which can be a CCD or CMOS image sensor, is disposed inside the frame. The video signal capturer 32 and the IR LED's 31 are connected to the host module 20 for using its electrical power and establishing signal communications. The sensor 12 is a passive IR (PIR) sensor, which detects IR radiation from a human body to determine whether any person is approaching. In addition to the PIR sensor, the sensor can be a sensing element in other forms (e.g. radio-frequency). In this embodiment, the microphone 11 and the sensor 12 are disposed on the handle 13 of the door 10. The microphone 11, the sensor 12, and the night-vision camera module 30 are connected with the host module 20 via flat ribbon wires.

The host module 20 is enclosed by a case. Elements outside the case include a touch-control liquid crystal display (LCD) 22 with a touch panel and a portable storage medium connecting interface for the connection of a portable storage medium. The portable storage medium connecting interface is a memory card connector 23, and the portable storage medium is a memory card. The memory card may be any standard memory card on the market, such as the SD, MMC, XD, MS, or CF card.

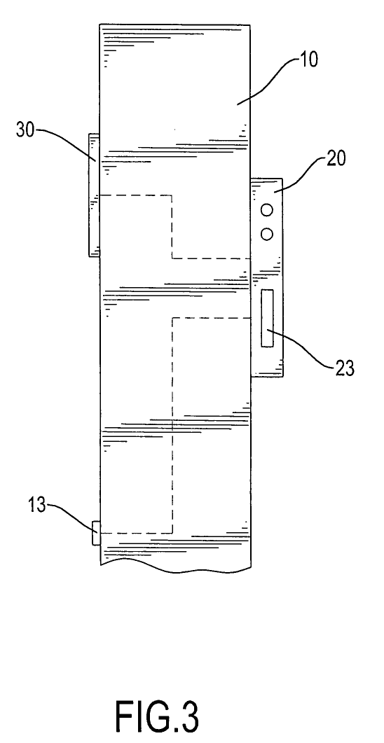

The inside of the host module 20 is disposed with a controlling/operating unit, as shown in FIG. 3. The controlling/operating unit includes: a multimedia processor 21, a digital/analog (D/A) converter 24, a high-definition multimedia interface (HDMI) 25, and a power supplying unit 26.

The multimedia processor 21 is the operating/controlling center and has several I/O terminals in connections with the night-vision camera module 30, the microphone 11, the sensor 12, and the touch-control LCD 22. Moreover, the multimedia processor 21 has an audio/video (AV) data compression function. In this embodiment, the AV signals input from the night-vision camera module 30 and the microphone 11 are compressed in the MPEG-4 format.

The DA converter 24 is disposed on one output terminal of the multimedia processor 21 in order to convert the monitoring video data compressed in the digital format into analog data and transmit them to a home television for display.

The HDMI 25 is disposed on one output terminal of the multimedia processor 21 in order to convert the digital AV data into a high-resolution multimedia format. Afterwards, the converted data are directly transmitted to a home television or a community security monitoring system.

The power supplying unit 26 provides a DC working voltage to the above-mentioned components. The invention can be further built in with a high-capacity rechargeable battery for emergency power supply. Therefore, the monitoring task is not stopped by power outage.

The working principle of the invention is described as follows.

Before turning on the disclosed door monitor, a memory card is first inserted to the memory card connector 23 on the host module 20 for the multimedia processor 21 to read/write. Once the door monitor is turned on and functioning, the user enters monitoring criteria using the touch-control LCD 22.

For example, a time is set to determine whether any approaching person outside the door stays too long. As the time duration is set, the night-vision camera module 30 begin to be operative if any person approaches the door and stays over the predetermined time.

The sensor 12 first detects whether any person is approaching. If some person is approaching, the far IR radiation emitted by the body is detected by the sensor 12. The multimedia 21 then starts its timing. If the person leaves within the predetermined time, then the night-vision camera module 30 and the microphone 11 will not be activate. If the person stays over the predetermined time, then the multimedia processor 21 starts both the night-vision camera module 30 and the microphone 11 will start to conduct recording.

Those former captures image data, which are then sent to the touch-control LCD 22 for display. Moreover, the AC data captured by the night-vision camera module 30 and the microphone 11 are simultaneously compressed in a specific format. The compressed data are written into the memory card via the memory card connector 23. Since a portable storage medium is used for storing the data, it can be readily removed from the host module 20 for copying and other purposes.

This invention provides a door monitor by having a portable storage medium. It will automatically monitor around the clock for any unusual situations happen. Data storage medium uses memory card, as the storage device. Therefore, it is easy in installation, operate and portable carrying. Obviously, the invention has made a lot of progress than the current peephole design that is available in the current market.

What is claimed is:

1. A security door monitor having a portable storage medium, comprising:
a night-vision camera module mounted outside a door for capturing images outside the door;
a microphone for capturing sounds outside the door;
a sensor for detecting whether any object is approaching the door from outside; and
a host module mounted behind the door and in signal communications with the night-vision camera module, the microphone, and the sensor having
a box;
a touch-control liquid crystal display (LCD) disposed outside the case;
a portable storage medium connecting interface provided on the case; and
a multimedia processor mounted in the box to connect to the touch-control LCD, the microphone, the sensor, and the portable storage medium connecting interface.

2. A door monitor having a portable storage medium as in claim 1, wherein the night-vision camera module has a frame, a plurality of infrared (IR) light-emitting diodes (LED's) mounted around the frame for night-vision illumination, and an image capturer mounted inside the frame.

3. A door monitor having a portable storage medium as in claim 2, wherein the image capturer is a CCD or CMOS image sensor.

4. A door monitor having a portable storage medium as in claim 1, wherein the multimedia processor is further connected with a digital-analog (D/A) converter for converting compressed digital monitoring image data into analog data and sending the analog data to a television or community security monitoring system.

5. A door monitor having a portable storage medium as in claim 1, wherein the multimedia processor is further connected with a high-definition multimedia interface (HDMI).

6. A door monitor having a portable storage medium as in claim 1, wherein the sensor is a passive infrared (PIR) sensor.

7. A door monitor having a portable storage medium as in claim 1, wherein the portable storage medium connecting interface is a memory card connector and the portable storage medium is a memory card.

8. A door monitor having a portable storage medium as in claim 1, wherein the image compression format of the multimedia processor is MPEG-4.

9. A door monitor having a portable storage medium as in claim 1, wherein the host module has a power supplying unit for providing a DC working voltage and built in with a high-capacity rechargeable battery.

10. A door monitor having a portable storage medium as in claim 2, wherein the host module has a power supplying unit for providing a DC working voltage and built in with a high-capacity rechargeable battery.

11. A door monitor having a portable storage medium as in claim 3, wherein the host module has a power supplying unit for providing a DC working voltage and built in with a high-capacity rechargeable battery.

12. A door monitor having a portable storage medium as in claim 4, wherein the host module has a power supplying unit for providing a DC working voltage and built in with a high-capacity rechargeable battery.

13. A door monitor having a portable storage medium as in claim 5, wherein the host module has a power supplying unit for providing a DC working voltage and built in with a high-capacity rechargeable battery.

14. A door monitor having a portable storage medium as in claim 6, wherein the host module has a power supplying unit for providing a DC working voltage and built in with a high-capacity rechargeable battery.

15. A door monitor having a portable storage medium as in claim 7, wherein the host module has a power supplying unit for providing a DC working voltage and built in with a high-capacity rechargeable battery.

16. A door monitor having a portable storage medium as in claim 8, wherein the host module has a power supplying unit for providing a DC working voltage and built in with a high-capacity rechargeable battery.

17. A door monitor having a portable storage medium as in claim 4, wherein the multimedia processor is further connected with a digital-analog (D/A) converter for converting compressed digital monitoring image data into analog data and sending the analog data to a television or community security monitoring system; and a high-definition multimedia interface (HDMI); wherein the portable storage medium connecting interface is a memory card connector and the portable storage medium is a memory card.
